(19) United States
(12) Patent Application Publication
(10) Pub. No.: US 2004/0250778 A1
(43) Pub. Date: Dec. 16, 2004

(54) Pet cooling collar

(76) Inventors: Jacqueline A. Bennis, Wayzata, MN (US); Susan Skramstad, Spicer, MN (US)

Correspondence Address: Mark A. Litman & Associates, P.A., York Business Center, Suite 205, 3209 West 76th St., Edina, MN, 55435, US

(21) Appl. No.: 10/458,447

(22) Filed: Jun. 10, 2003

(51) Int. Cl. A62B 35/00

(52) U.S. Cl. 119/858

(57) ABSTRACT

A thermal treatment device for the neck of animals comprises three distinct elements: 1) a cover element, 2) a thermal (e.g., preferably cooling) element within the cover element and 3) an attachment element within the cover element (and preferably within the thermal element). The device may be comfortably secured about the neck of the animal and the thermal element may comfort the neck and generally the body of the animal. The thermal treatment element is activated (e.g., refrigerated), then associated with the cover element and the attachment element and applied to the animal. The activation may also be done while the thermal treatment element is already associated with one or more of the cover element and the attachment element.

### BACKGROUND OF THE INVENTION

1. Field of the Invention

The present invention relates to collars for (non-human) animals and especially for collars that have a hot/cold therapeutic effect.

2. Background of the Invention

The use of cold packs and hot packs for thermal therapy is known. Cold and hot packs may be of several general types. One type of cold pack contains an insulating material which, upon cooling in a refrigerator or freezer, gradually warms back to ambient temperature. Similarly, another type of hot pack contains an insulating material that can be warmed, applied against a body, and then cools down over time. Another type of thermal pack operates via a change of phase or chemical state of the components of the pack. Still another type of thermal pack employs chemical components that are endotherm-producing in the case of cold packs, or exotherm-producing in the case of hot packs, on dissolution in a solvent. Phase change materials may be converted between solid and liquid phase and utilize a latent heat of fusion to absorb, store and release heat, or cool, during such phase conversion. Ice/water is one example of phase change material.

Certain chemical compounds, once dissolved into a solution, result in either a lowering of the temperature of the solution below or above ambient temperature. On dissolution, these compounds absorb heat from, or expend heat to, the surrounding environment. For example, inorganic salts or soluble organic compounds known to have positive enthalpy of aqueous solution are used to make the reduced temperature solutions useful in cold packs. In the case of hot packs, compositions having negative enthalpy of aqueous solution are used to produce increased temperature solutions useful for hot packs.

Examples of cold packs that employ an insulating material are cold packs that contain a gel. Typically, these cold packs are cooled in a refrigerator or freezer. For cold therapy, once cooled, the cold pack is placed on the injured or sore area and thus provides the cold therapy.

Chemical cold packs that provide an insulating layer between the cold pack and the skin are also known. One such cold pack uses an outer pouch containing capillaries to allow drainage of the pack and to provide a temperature moderating effect. Another chemical cold pack uses a wetting member in contact with the chemical cold pack, thereby providing moist cold to an injury. Yet another chemical cold pack positions an absorbent/insulating layer between the chemical cold and the ambient air with the chemical cold pack placed up against the patient's skin. In this device, the surface area of the absorbent/insulating layer is smaller than the surface area of the cold pack. Examples of cold packs that employ an insulating material include cold packs that contain gelling agents, such as the thermal packs described in Williams U.S. Pat. No. 3,804,077 and Dunshee et al. U.S. Pat. No. 4,462,224. For example, these cold packs are cooled in a refrigerator or freezer. Once cooled, the cold pack is placed on the injured or sore area and thus provides cold therapy. Typical gels used in this type of cold pack are based on the gelation of xanthan gum, locust bean gum, gum tragacanth, guar gum, hydroxypropyl methylcellulose, absorbent poylmers, and the like. Gels may also be based on a high molecular weight polyacrylic acid cross-linked with a polyalkenyl ether, also referred to as cis-carbomers.

Other examples of cold packs that employ an insulating material exist in the art. For example, cold packs may employ an outer insulative layer. Alternatively, clays or silicates can be used in conjunction with cold therapy providing chemicals to form aqueous colloidal dispersions sometimes referred to as gels. These colloidal dispersions perform a similar life-extending function due to steric hindrance provision during dissolution.

Phase change materials can be converted between solid and liquid phases and utilize their latent heat of fusion to cool or heat during such phase conversion. The latent heats of fusion are greater than the sensible heat capacities of the materials. Accordingly, the amount of energy absorbed upon melting or released upon freezing is greater than the amount of energy absorbed or released upon increasing or decreasing the temperature of the material by 10° C. within a phase. Water or the silica based materials described in Salyer U.S. Pat. No. 5,211,949 are examples of phase change materials.

Thermal packs which employ gelling agents are included in the third category of methods for extending the life of cold and hot packs. The gelling agents can be included in the same container as the endotherm-producing or exotherm-producing chemical. One example of a typical gelling agent is hydroxypropylmethylcellulose. When initiated, the endotherm-producing chemical reduces the temperature of the cold pack and the gelling agent gels. The formed gel provides some level of dissolution hindrance so the rate of dissolution is decreased.

Alternative means to cool or heat injuries have been devised. U.S. Pat. No. 5,383,921 describes a heat and/or cold device in the form of a muff into which the hands, wrists, arms or legs can be inserted. U.S. Pat. No. 4,592,358 discloses a device featuring a plurality of compartments enclosing a therapeutic substance, that may be heated or cooled, which may be firmly positioned on various body portions using one or more strap means. U.S. Pat. No. 4,951,666 describes a thermal pack consisting of a porous outer bag and a nonporous inner bag for use in treating localized injuries such as the knee. U.S. Pat. No. 5,133,348 discloses a hot or cold pack with a main body portion and four radially extending portions attached thereto and integral therewith which is applied to a curved contour such as breast, knee, ankle, shoulder or other body areas. U.S. Pat. No. 4,530,220 describes a deformable bag comprised of small pieces of gel packed in a flexible envelope for use as a cooling medium which can be applied on different objects or portions having various configurations. U.S. Pat. No. 3,736,769 discloses a cooling device having a core of cold storing material sandwiched between two thin, flexible walls having different heat transfer rates such that the one side of the cooling device is colder to the touch than the opposite side of the device. Other cooling agents are shown in U.S. Pat. No. 6,099,555.

One area of the body that particularly benefits from thermal (hot or cold) therapy is the neck. Many different designs and structures have been shown for either thermal therapy alone or combined support and thermal therapy, as shown in U.S. Pat. Nos. 5,211,623; 4,745,922; 4,671,049; 4,832,030; 4,805,619; 4,576,169; 6,152,953; 5,257,429; 5,247,928; and 5,265,669. Non-human animals may also benefit from the application of thermal treatments to the body and neck and shown by some of the above-listed U.S. patents.

Among the significant problems encountered by the above designs are the complexity of the structures and the tendency of the structures to become irretrievably dirtied on use, especially with animals.

### SUMMARY OF THE INVENTION

A thermal treatment device for the neck of animals comprises three distinct elements: 1) a cover element, 2) a thermal (e.g., preferably cooling) element within the cover element and 3) an attachment element within the cover element (and preferably within the thermal element). The device may be comfortably secured about the neck of the animal and the thermal element may comfort the neck and generally the body of the animal. The thermal treatment element is activated (e.g., refrigerated), then associated with the cover element and the attachment element and applied to the animal. The activation may also be done while the thermal treatment element is already associated with one or more of the cover element and the attachment element.

### BRIEF DESCRIPTION OF THE FIGURE

FIG. 1 shows a thermal treatment neck device of he present invention.

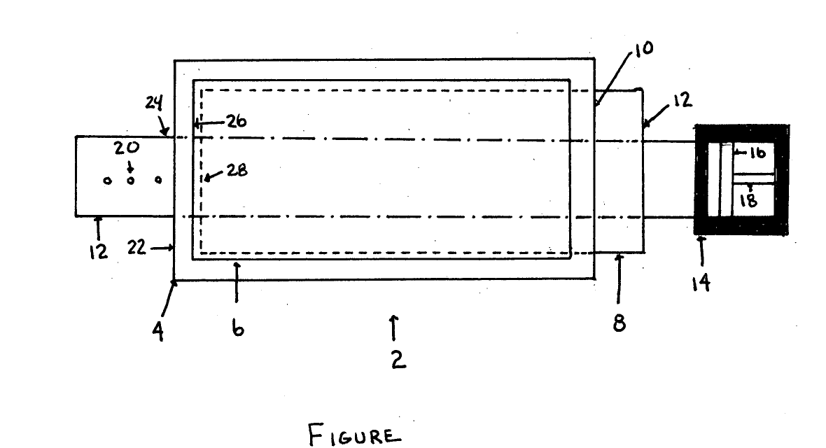

### DETAILED DESCRIPTION OF THE INVENTION

A thermal treatment device of the present invention may be applied to various parts of the body of animals. Although the design is particularly suitable for application about the neck of non-human animals, by minor variations in size and proportions, the device may be applied to other parts of animal bodies, including humans. The design is intended to provide a simple, readily used, and readily exchanged thermal treatment device (particularly a cooling device) that can be readily cleaned and reused, even without cleaning.

Reference to the FIGURE will assist in an appreciation of the practice of the present invention. The FIGURE shows a thermal treatment device 2 having three component parts shown. In the thermal treatment device 2 there is a cover 4, a thermal treatment component or pack 8 and an attachment element 12. The cover 4 is shown with stitching 6 that defines portions of the structure of the cover element 4. The cover element may be made of any flexible or conformable material that is not so heat insulating that it prevents heat flow across its surface. Such materials as thin fabric, thin film, paper, mesh and the like are non-limiting examples of structures that can be used for the cover element. Preferred materials include polyamides, polyesters, polyvinyl resins, polyolefin resins, paper, natural fibers and the like. The cover may be either washable or disposable at the option of the designer or user. The cover should be open at both ends 10 and 22 to allow the other elements (e.g., the thermal treatment element 8 and the attachment element 12) to pass through the cover 4. The thermal treatment element may be able to pass through the holes/openings on either end (10 or 22) of the cover element 4 or may be blocked at one end 22 so that only the attachment element 12 will have a portion 24 that passes through the end 22 of the cover 4. This can be easily accomplished by having the stitching 6 extend over an area or length 26 that will block passage of the thermal treatment pack from passing out of end 22. The rate of thermal transfer (into or out of the device, depending upon whether it is a heat treatment or a cooling treatment) can be partially controlled by the insulating properties of the cover 4. The less insulating the cover, the more rapid is the transfer of heat across the cover 4.

The thermal treatment element 12 may comprise any material or structure that can carry thermal treatment. Usually the thermal treatment element should be a flexible/conformable structure and material that has a significant heat capacity so that significant amounts of heat may be stored or significant amounts of heat may be absorbed into the cooled structure. It is also desirable to have a cover layer that entraps the material with a high heat capacity. A typical structure would comprise a packet (e.g., polymeric, non-porous enclosed structure) that contains a material having a significant heat capacity. It is preferred that the material have a heat capacity of at least 0.9 that of water, preferably at least equal to that of water, and more preferably greater then that of water. Ice or slush that enables the packet to be flexible is also particularly usable because of the phase change that is required to melt the ice. Gel materials, which may also display phase changes or pseudo-phase changes are also particularly used. Examples of these gels are described in the prior art described above, which references are incorporated herein by reference for their disclosure of coolant and heating materials.

The attachment element 12 may be a strap that passes through the ends 12 and 28 of the thermal treatment element 8 which in turn passes through the cover 4. The attachment element 12 in the Figure is shown as a strap with a buckle end 14 and holes 20 at the other end. The buckle end 14 has a cross bar 16 that supports a pinning element 18 that locks into holes 20 to restrain movement and adjust the fit of the thermal treatment device 2. Other restraining and adjusting systems may be used, such as hook-and-loop fasteners (e.g., Velcro®), adhesives, snaps, clips, ties and the like. A particular benefit of this structure is that even though the thermal treatment element 8 may be slid easily into the cover, the attachment element secures the thermal treatment element to the user. By unfastening the attachment element, the cover 4 and the thermal treatment element 8 may be easily slid from the attachment element. The cover can be separately washed or periodically replaced at the discretion of the user.

The device may be used with any animal where cooling might be desirable, but is particularly useful for household pets such as cats, dogs and other small mammals.

Other variations in structure and composition will be obvious to those of ordinary skill in the art, yet remain within the scope of the invention and the claims.

1. A thermal treatment device for use on a body comprising:
a cover having a first end and a second end and space therein;
all of said space within the cover filled with a single slideable element consisting of a thermal treatment element that can store heat or absorb heat slideably within the cover and having an engaging portion for accepting an attachment device; and
the attachment device having a proximal end and a distal end, the attachment device being able to be secured to itself at the distal end and the proximal end.

2. The device of claim 1 wherein the engaging portion in the thermal treatment element comprises loops on the side of the thermal treatment element.

3. The device of claim 1 wherein the engaging portion of the thermal treatment element comprises a passage through the thermal treatment element.

4. The device of claim 1 wherein the thermal treatment element comprises a material that when cooled absorbs heat and has a beat capacity greater then that of water.

5. The device of claim 2 wherein the thermal treatment element comprises a material that when cooled absorbs heat and has a heat capacity greater then that of water.

6. The device of claim 3 wherein the thermal treatment element comprises a material that when cooled absorbs heat and has a heat capacity greater then that of water.

7. The device of claim 4 wherein the thermal treatment element comprises a material that when cooled absorbs heat and has a heat capacity greater then that of water.

8. The device of claim 3 wherein the thermal treatment element contains a gel with a heat capacity greater then that of water.

9. The device of claim 3 wherein the attachment device is a strap with a securing system selected from the group consisting of buckles, clips, and hook-and-loop fasteners.

10. The device of claim 7 wherein the attachment device is a strap with a securing system selected from the group consisting of buckles, clips, and hook-and-loop fasteners.

11. The device of claim 8 wherein the attachment device is a strap with a securing system selected from the group consisting of buckles, clips, and hook-and-loop fasteners.

12. The device of claim 1 wherein the cover, the thermal treatment element and the attachment element comprise synthetic polymeric materials.

13. A method of comforting an animal selected from the group consisting of cats and dogs comprising cooling the thermal treatment element of the device of claim 1 and then applying the thermal treatment device to the neck of the en animal and attaching the attachment element to secure the thermal treatment device to the neck of the animal.

14. (CANCELLED)

15. The method of claim 13 wherein the engaging portion of the thermal treatment element comprises a passage through the thermal treatment element.

16. The method of claim 13 wherein the thermal treatment element comprises a material that when cooled absorbs beat and has a heat capacity greater then that of water.

17. The method of claim 13 wherein the attachment device is a strap with a securing system selected from the group consisting of buckles, clips, and hook-and-loop fasteners.

18. The method of claim 16 wherein the attachment device is a strap with a securing system selected from the group consisting of buckles, clips, and hook-and-loop fasteners.
